(19) United States
(12) Patent Application Publication
(10) Pub. No.: US 2014/0160055 A1
(43) Pub. Date: Jun. 12, 2014

(54) WEARABLE MULTI-MODAL INPUT DEVICE FOR AUGMENTED REALITY

(71) Applicants: Jeffrey Margolis, Seattle, WA (US); Nathan Ackerman, Seattle, WA (US); Sheridan Martin, Kihei, HI (US)

(72) Inventors: Jeffrey Margolis, Seattle, WA (US); Nathan Ackerman, Seattle, WA (US); Sheridan Martin, Kihei, HI (US)

(21) Appl. No.: 13/712,493

(22) Filed: Dec. 12, 2012

(51) Int. Cl. G06F 3/041; G06F 3/044

(52) U.S. Cl. CPC G06F 3/041; G06F 3/044
USPC 345/174; 345/173

(57) ABSTRACT

A wrist-worn input device that is used in augmented reality (AR) operates in three modes of operation. In a first mode of operation, the input device is curved so that it may be worn on a user's wrist. A touch surface receives letters gestured or selections by the user. In a second mode of operation, the input device is flat and used as a touch surface for more complex single or multi-hand interactions. A sticker defining one or more locations on the touch surface that corresponds a user's input, such as a character, number or intended operation, may be affixed to the touch surface. The sticker may be interchanged with different stickers based on a mode of operation, user's preference and/or particular AR experience. In a third mode of operation, the input device receives biometric input from biometric sensors. The biometric input may provide contextual information in an AR experience while allowing the user to have their hands free.

### BACKGROUND

An augmented reality (AR) system includes hardware and software that typically provides a live, direct or indirect, view of a physical, real world environment whose elements are augmented by computer-generated sensory information, such as sound, video and/or graphics. For example, a head mounted display (HMD) may be used in an AR system. The HMD may have a display that uses an optical see-through lens to allow a computer generated image (CGI) to be superimposed on a real-world view.

A variety of single function input devices may be used in an AR system to captures input, experience or indicate user's intent. For example, tracking input devices, such a digital cameras, optical sensors, accelerometers and/or wireless sensors may provide user input. A tracking input device may be able to discern a user's intent based on the user's location and/or movement. One type of tracking input device may be a finger tracking input device that tracks a user's finger on a computer generated keyboard. Similarly, gesture recognition input devices may interpret a user's body movement by visual detection or from sensors embedded a peripheral device, such as a wand or stylus. Voice recognition input devices may also provide user input to an AR system.

### SUMMARY

A wrist-worn input device that is used in a AR system operates in three modes of operation. In a first mode of operation, the input device is curved so that it may be worn on a user's wrist. A touch surface receives letters gestured or selections by the user.

In a second mode of operation, the input device is flat and used as a touch surface for more complex single or multi-hand interactions. The input device includes one or more sensors to indicate the orientation of the flat input device, such as portrait, landscape, one handed or two handed. The input device may include a processor, memory and/or wireless transmitter to communicate with an AR system.

In a third mode of operation, the input device receives biometric input from one or more biometric sensors. The biometric input may provide contextual information while allowing the user to have their hands free. The biometric sensors may include heart rate monitors, blood/oxygen sensors, accelerometers and/or thermometers. The biometric mode of operation may operate concurrently with either the curved or flat mode of operation.

A sticker defining one or more locations on the touch surface that corresponds a user's input, such as a character, number or intended operation, may be affixed to the touch surface. The sticker may be interchanged with different stickers based on a mode of operation, user's preference and/or particular AR experience. The sticker may be customizable as well. A sticker may include a first adhesive surface to adhere to the touch surface and a second surface that provides a user-preferred keyboard and/or keypad layout with user preferred short cut keys.

In an embodiment, an input device comprises a touch surface that receives a touch input from a user. A member is coupled to the touch surface and is curved around a wrist of the user in a first mode of operation. The member is flat in a second mode of operation. A biometric sensor also receives a biometric input from the user. A transmitter outputs a signal that represents the touch and biometric inputs.

In another embodiment, an input device used to experience augmented reality comprises a member that may be curved or extended flat. A capacitive touch surface is coupled to the member and receives a touch input from the user. A sticker is coupled to the touch surface and defines one or more locations on the touch surface that corresponds to a user's input. A biometric sensor also receives biometric input from the user. A processor executes processor readable instructions stored in memory in response to the touch and biometric input.

In still another embodiment, an AR apparatus comprises an input device and computing device that provides an electronic signal representing augmented reality information. The input device includes a member that may be curved to be worn by the user or flat. A touch surface is coupled to the member and receives touch input from the user. A biometric sensor, such as a heart rate and/or blood/oxygen sensor, also receives biometric input from the user. A processor executes processor readable instructions stored in memory in response to the touch and biometric input. A wireless transmitter outputs a wireless signal that represents the touch and biometric input. The computing device then provides the electronic signal representing augmented reality information in response to the wireless signal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a view of a wearable input device on a user's wrist.

FIG. 2 is a view of a wearable input device in a curved mode of operation

FIG. 3 is a view of a wearable input device in a flat mode of operation.

FIG. 4A schematically shows an exploded of a flexible mechanism of a wearable input device.

FIG. 4B schematically shows an elongated rib member that mechanically interlocks with a bottom flexible support in a flexible mechanism.

FIG. 5A schematically shows a cross section of elongated rib members.

FIG. 5B schematically shows an enlarged view of neighboring elongated rib members.

FIG. 5C schematically shows an enlarged view of example neighboring scales.

FIG. 6 schematically shows an example elongated rib member that includes a left projection and a right projection.

FIG. 7 is a front view of a wearable input device in a flat mode of operation having a touch surface.

FIG. 8 is a back view of wearable input device in a flat mode of operation having various electronic components.

FIG. 9 illustrates using the wearable input device in a AR system.

FIGS. 10A-B are flow charts illustrating methods of operating a wearable input device.

FIG. 11A is a block diagram depicting example components of an embodiment of a personal audiovisual (AV) apparatus having a near-eye AR display and a wired wearable input device.

FIG. 11B is a block diagram depicting example components of another embodiment of a AV apparatus having a near-eye AR display and a wireless wearable input device.

FIG. 12A is a side view of a HMD having a temple arm with a near-eye, optical see-through AR display and other electronics components.

FIG. 12B is a top partial view of a HMD having a temple arm with a near-eye, optical see-through, AR display and other electronic components.

FIG. 13 illustrates is a block diagram of a system from a software perspective for representing a physical location at a previous time period with three dimensional (3D) virtual data being provided by a near-eye, optical see-through, AR display of a AV apparatus.

FIG. 14 illustrates is a block diagram of one embodiment of a computing system that can be used to implement a network accessible computing system.

### DETAILED DESCRIPTION

User input in AR systems has been approached from many different directions, often times requiring many different single-function devices to capture input. These devices accomplish their goal, but are optimized for use in a single scenario that does not span a variety of scenarios in a typical day of user activity. For example, a touch device may allow for great user input when a user's hands are free, but a touch device may becomes difficult to use when a user is carrying groceries or otherwise has their hands full. The present technology supports user input through a wide range of scenarios with at least three different input modalities that allow users to accomplish their daily goals while paying attention to social and physical/functional constraints.

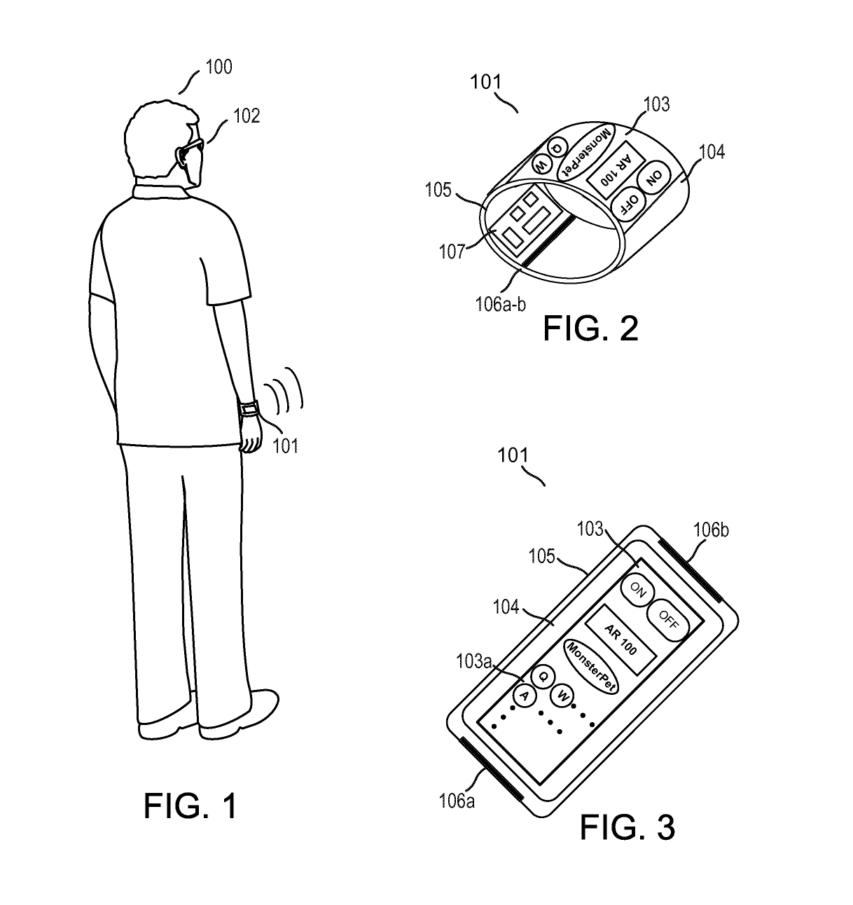

FIG. 1 is a view of a wearable input device 101 that may be worn by a user 100. In an embodiment, a user 100 may also use a HMD 102 to view a CGI superimposed on a real-world view in an AR system. Wearable input device 101 may receive multiple types of inputs from user 100 in various modes of operation. A surface 104 of wearable input device 101 is used as a touch surface to receive input, such as letters and/or other gestures by user 100. Surface 104 may also receive input that indicates a selected character or input when a user touches a predetermined location of surface 104. Wearable input device 101 may also receive biometric information input of user 100 from one or more biometric sensors in wearable input device 101. The input information may be communicated to an AR system by way of wired or wireless communication.

A wearable input device 100 is capable of operating in at least three modes operation. In a first mode of operation, wearable input device 101 may be curved (or folded) so that in may be worn on user 100 as illustrated in FIGS. 1 and 2. While FIG. 1 illustrates user 100 positioning wearable input device 100 on a wrist, wearable input device 101 may be worn on other locations in alternate embodiments. For example, wearable input device 101 may be worn on the upper arm or upper thigh of a user.

Wearable input device 100 may form an open curve (like the letter “C”) or closed curve (like the letter “O) in various curved modes of operation embodiments. FIG. 2 illustrates a wearable device 101 that is in a closed position by using fasteners 106a-b. In an embodiment, fasteners 106a may be a buckle, fabric and loop fastener, button, snap, zipper or other equivalent type of fastener. In alternate embodiments, fasteners 106a-b is not used. In an open curved mode of operation, wearable input device 101 may be sized to fit a wrist of user 100. In an embodiment, wearable input device 101 may have a hinge to secure to a wrist of user 100.

In a second mode of operation, wearable input device 101 may be flat and/or rigid, as illustrated in FIG. 3, so that user 100 may provide more complex single or multi-hand interactions. For example in a flat mode of operation, a user 100 may prepare a text message by touching multiple locations of surface 104 that represent alphanumeric characters.

In a third mode of operation, wearable input device 101 receives biometric information of user 100 from one or more biometric sensors in electronic components 107 positioned on the back of wearable input device 101. In alternate embodiments, one or more biometric sensors may be positioned in other locations of wearable input device 101. The biometric information may provide contextual information to a AR system while allowing user 100 to have their hands free. The biometric sensors may include heart rate sensors, blood/oxygen sensors, accelerometers, thermometers or other type of sensor that obtains biometric information from a user 100. The biometric information may identify muscle contractions of the arm and/or movement of the arm or other appendage of user 100.

In embodiments, wearable input device 101 may be in either a flat or curved mode of operation as well as a biometric mode of operation. In still a further embodiment, wearable input device 101 may be in a biometric mode of operation and not be able to receive touch input.

Wearable input device 101 includes a member 105 that enables wearable input device 101 to be positioned in a curved or flat mode of operation. A touch surface (or layer) 104 is then positioned on member 105 to receive user 100 inputs. Touch surface 104 may be flexible and glued to member 105 in embodiments. In an embodiment, a sticker 103 that identifies where a user 100 may contact touch surface 104 for predetermined inputs is adhered to touch surface 104.

In embodiments, member 105 includes a type of material or composite that enables wearable input device 101 to be curved or extended flat during different modes of operation. For example, member 105 may include a fabric, bendable plastic/foam and/or bendable metal/alloy. In other embodiments, member 105 may include a wire frame or mesh covered with a plastic sleeve or foam. In a flat mode of operation, member 105 may be rigid or flexible in embodiments. Similarly, in a curved mode of operation, member 105 may be rigid or flexible. In an embodiment, member 105 may be a mechanical mechanism having a plurality of rib members and overlapping scales that enable a curved and flat mode of operation as described herein.

Member 105 may have a variety of geometric shapes in embodiments. While FIGS. 1-3 illustrate a member 105 that may be rectangular (in a flat mode of operation) or cylindrical (in a curved mode of operation), member 105 may have other geometric shapes to position touch surface 104.

In an embodiment, a touch surface 104 is an electronic surface that can detect the presence and location of a touch within an area. A touch may be from a finger or hand of user 100 as well as from passive objects, such as a stylus.

In various embodiments, touch surface 104 includes different touch surface technologies for sensing a touch from a user 100. For example, different touch surface technologies include resistive, capacitive, surface acoustic wave, dispersive signal and acoustic pulse technologies. Different types of capacitive touch surface technologies include surface capacitive, projected capacitive, mutual capacitive and self-capacitive technologies.

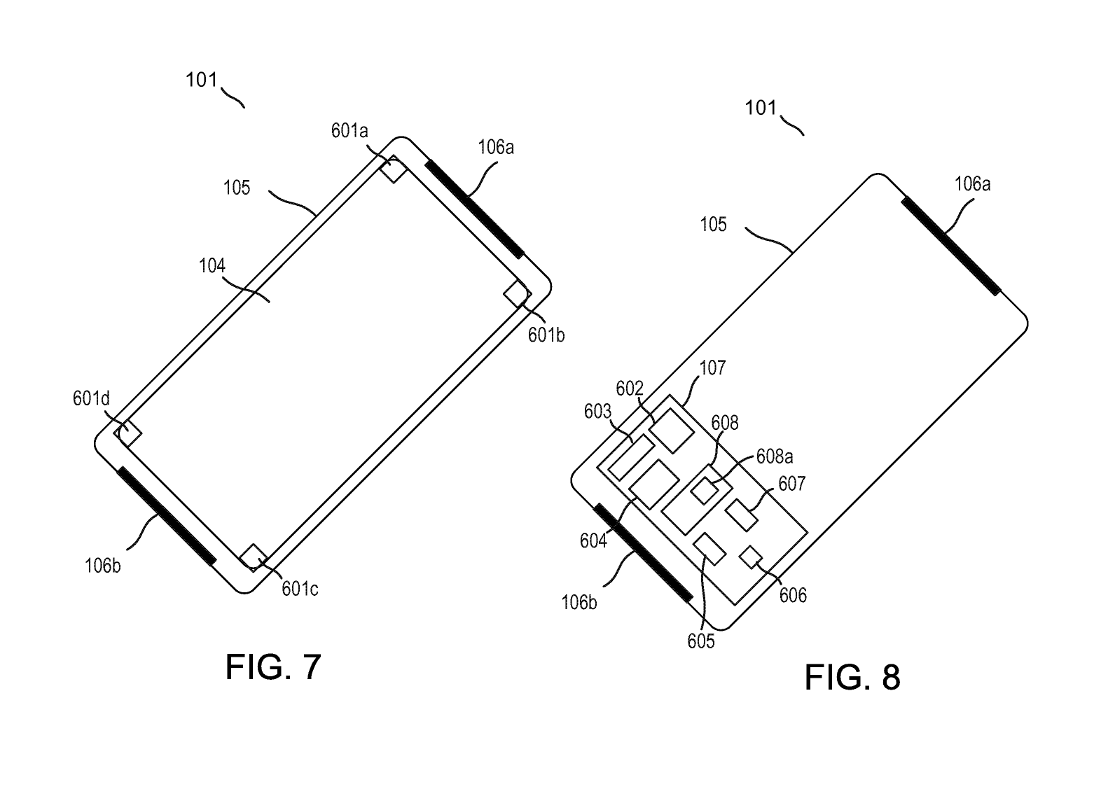

In an embodiment, touch surface 104 includes a two-dimensional surface capacitive touch surface. In an embodiment, a surface capacitive touch surface is constructed by forming a conducting material or layer, such as copper or indium tin oxide, on an insulator. A small voltage is applied to the conducting layer to produce a uniform electrostatic field. When a conductor, such as a human finger, touches the uncoated surface of the insulator, a capacitor is dynamically formed. A controller and touch surface driver software in electronics components 107 then determines the location of the touch indirectly from the change in the capacitance as measured from one or more sensors at four corners of the touch surface 104 as illustrated in FIGS. 7 and 8.

In an embodiment, sticker 103 includes a first surface providing a key or user input layout and a second surface having adhesive to affix to touch surface 104. In alternate embodiments, sticker 103 (and/or touch surface 104) may include a different type of bonding mechanism (other than adhesive) in affixing a surface having a key or user input layout to touch surface 104. For example, sticker 103 may be bonded to touch surface 104 by using a static-cling type bond, molecular bond, magnetic outer rim and/or other type of bonding mechanism. Sticker 103 includes a key layout representing locations for a user 100 to touch on surface 104 so that a predetermined AR function may be initiated, a short cut initiated and/or character input. For example, sticker 103 includes “ON” and “OFF” keys as well as “AR 100” and “MonsterPet” keys. In an embodiment, sticker 103 also includes keypad 103a having alphanumeric characters. In embodiments, a user may customize sticker 103 for functions that are often used. For example, sticker 103 includes a “MonsterPet” key that identifies a location on touch surface 104 that after touching, would create an AR monster pet for viewing in a AR system as described herein.

A user may also remove and replace sticker 103 with another sticker that may be used in a different AR application. For example, sticker 103 may be replaced with sticker that has a more detailed keypad 103a having more characters when user 100 intends to create a text message to be sent to another.

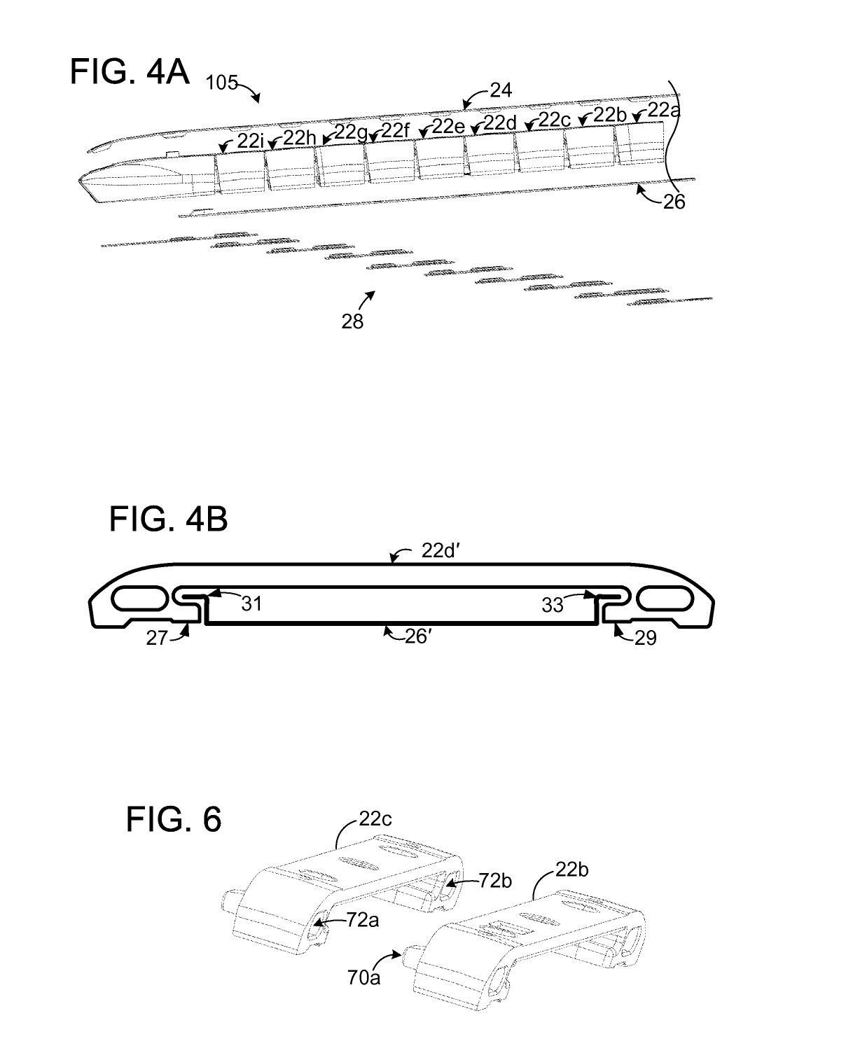

FIG. 4A shows an exploded view of member 105 in a flat mode of operation. Member 105 includes a plurality of elongated rib members 22a-22i, a top flexible support 24, a bottom flexible support 26, and a plurality of overlapping scales 28. The plurality of elongated rib members is disposed between the top and bottom flexible supports. The second flexible support is disposed between the plurality of overlapping scales and the plurality of elongated rib members.

In this example embodiment, there are nine elongated rib members. It will be appreciated that more or fewer ribs may be included in alternative embodiments. Each elongated rib member is longer across its longitudinal axis (i.e., across the width of wearable input device 101) than across its latitudinal axis (i.e., from the top of wearable input device 101 to the bottom of wearable input device 101). In the illustrated embodiment, each elongated rib member is at least four times longer across its longitudinal axis than across its latitudinal axis. However, other ratios may be used.

FIG. 4B schematically shows a cross section of an elongated rib member 22d′ and bottom flexible support 26′. As shown in this example, the elongated rib members and/or the bottom flexible support may be configured to mechanically interlock. In this example, the elongated rib member includes a shelf 27 and a shelf 29, and the bottom flexible support includes a catch 31 and a catch 33. Shelf 27 is configured to engage catch 31 and shelf 29 is configured to engage catch 33. As such, elongated rib member 22d′ is able to allow the bottom flexible support to slide relative to the elongated rib member without becoming separated from the elongated rib member when the wearable input device 101 is moved into the curved mode of operation. In other embodiments, a bottom flexible support may be connected to an intermediate catch, and the intermediate catch may interlock with a shelf of an elongated rib member to hold the bottom flexible support to the elongated rib member. While elongated rib member 22d′ is used as an example, it is to be understood that other elongated rib members may be similarly configured.

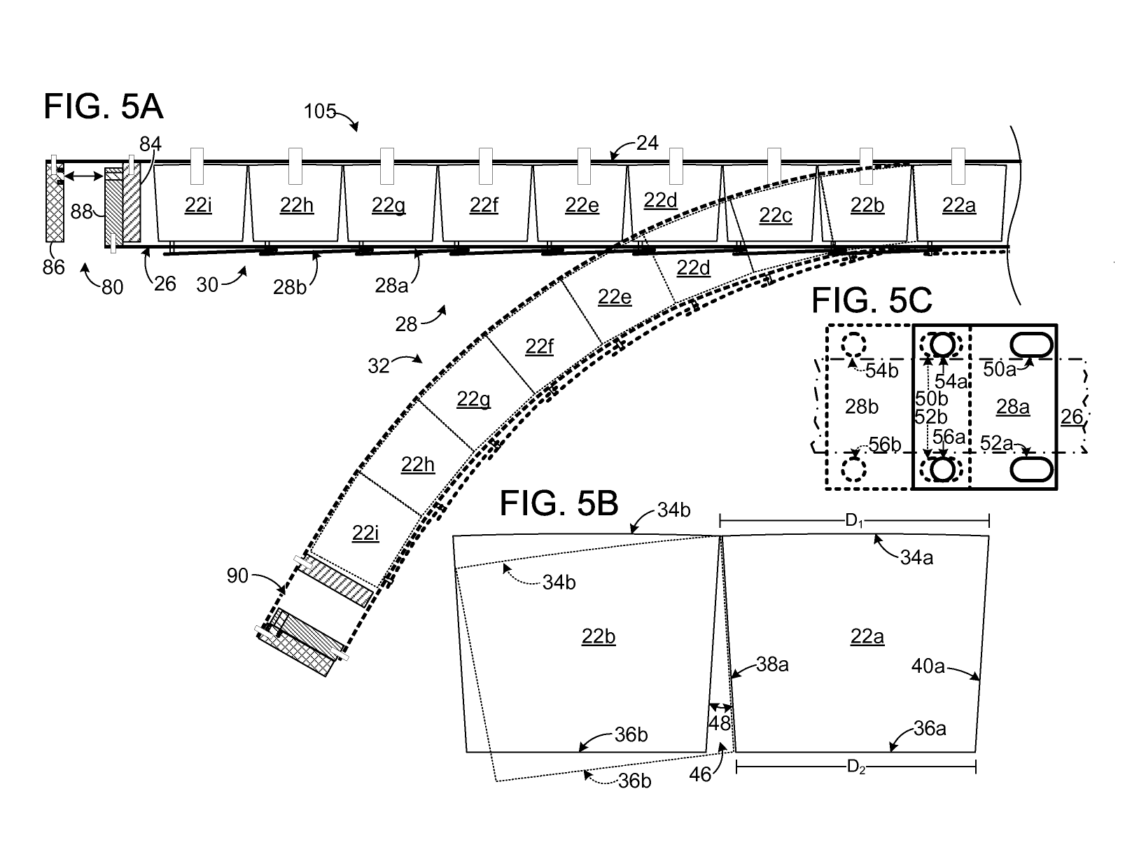

FIG. 5A schematically shows a cross section of the elongated rib members 22a-22i. At 30, the elongated rib members are shown in the flat mode of operation, indicated with solid lines. At 32, the elongated rib members are shown in the curved mode of operation, indicated with dashed lines. FIG. 5B is an enlarged view of elongated rib member 22a and elongated rib member 22b.

Each elongated rib member may have a generally trapezoidal cross section. As shown with reference to elongated rib member 22a, the generally trapezoidal cross section is bounded by a top face 34a; a bottom face 36a; a left side 38a between top face 34a and bottom face 36a; and a right side 40a between top face 34a and bottom face 36a. As shown, the top face 34a opposes the bottom face 36a and the left side 38a opposes the right side 40a.

Top face 34a has a width D1 and bottom face 36a has a width D2. D1 is greater than D2, thus giving elongated rib member 22a a generally trapezoidal cross section. However, it is to be understood that one or more elongated rib members may not have perfect trapezoidal cross sections. For example, top face 34a and/or bottom face 36a may be curved, non-planar surfaces. As another example, corners between faces and sides may include bevels and/or rounded edges. These and other variations from a true trapezoidal cross section are within the scope of this disclosure.

In some embodiments, the cross section of each elongated rib member may be substantially identical to the cross sections of all other elongated rib members. In some embodiments, at least one elongated rib member may have a different size and/or shape when compared to another elongated rib member. In general, the size, shape, and number of elongated rib members can be selected to achieve a desired curved mode of operation, as described below by way of example.

FIG. 5A also shows a cross section of top flexible support 24 and bottom flexible support 26. Top flexible support 24 is attached to fastener 106b and to each elongated rib member. In this example embodiment, two threaded screws and two rivets connect top flexible support 24 to fastener 106b. In other embodiments, top flexible support 24 and fastener 106b may be attached by alternative means, such as studs, heat staking, or a clasp.

Turning back to FIG. 5A, bottom flexible support 26 is attached to fastener 106b, but is not attached to all of the elongated rib members. In this example embodiment, three threaded screws and two rivets connect bottom flexible support 26 to fastener 106b. In other embodiments, bottom flexible support 26 and fastener 106b may be attached by alternative means, such as studs or a clasp.

Turning back to FIG. 5A, top flexible support 24 is configured to hold the elongated rib members in a spatially consecutive arrangement and guide them between the flat mode of operation and the curved mode of operation. In the flat mode of operation, the top faces of neighboring elongated rib members may be in close proximity to one another. Furthermore, top flexible support 24 may maintain a substantially equal spacing between the top faces of neighboring elongated rib members because the top flexible support is connected to the top face of each elongated rib member.

In contrast, the bottom faces of neighboring elongated rib members may be spaced farther apart than the top faces when wearable input device 101 is in the flat mode of operation. As an example, top face 34a is closer to top face 34b than bottom face 36a is to bottom face 36b as illustrated in FIG. 5B. This arrangement forms a gap 46 between elongated rib member 22a and elongated rib member 22b. As can be seen in FIG. 5A, a similar gap exists between each pair of neighboring elongated rib members.

When in a flat mode of operation, gap 46 is characterized by an angle 48 with a magnitude M₁. When in the curved mode of operation, angle 48 has a magnitude M₂, which is less than M₁. In some embodiments, including the illustrated embodiment, the gap may essentially close when wearable input device 101 is moved into the curved mode of operation (e.g., angle 48=0 degrees). Closing each gap between neighboring elongated rib members contributes to the overall curvature of member 105 in the curved mode of operation.

FIG. 5A also shows overlapping scales 28. Each of overlapping scales 28 may be connected to a pair of neighboring elongated rib members at the bottom faces of the elongated rib members. However, each overlapping scale may be slideably connected to at least one of the pair of neighboring elongated rib members so that gap 48 may close. Such a connection may allow wearable input device 101 to move from the flat mode of operation to a curved mode of operation and prevent wearable input device 101 from moving into a mode of operation in which member 105 bends backwards (i.e., opposite the curved mode of operation).

FIG. 5C shows an enlarged view of neighboring overlapping scales—namely overlapping scale 28a (shown in solid lines) and overlapping scale 28b (shown in dashed lines). Overlapping scale 28a has a forward slotted left hole 50a and a forward slotted right hole 52a. Overlapping scale 28a also has a rearward fixed left hole 54a and a rearward fixed right hole 56a. Similarly, overlapping scale 28b has a forward slotted left hole 50b, a forward slotted right hole 52b, a rearward fixed left hole 54b, and a rearward fixed right hole 56b. Each overlapping scale may be configured similarly.

A fastener such as a rivet may attach neighboring overlapping scales to an elongated rib member. For example, a rivet may be fastened through holes 54a and 50b. Similarly, a rivet may be fastened through holes 56a and 52b. Such rivets may attach both overlapping scales to the same elongated rib member (e.g., elongated rib member 22g of FIG. 5A).

In such an arrangement, the fixed holes (e.g., hole 54a and hole 56a) may be sized to closely fit the rivet so that overlapping scale 28a does not slide relative to the elongated rib member. In contrast, the slotted holes (e.g., hole 50b and hole 52b) may be sized to allow fore and aft sliding relative to the elongated rib member. In this way, each overlapping scale can be fixed to one elongated rib member and may slide relative to another elongated rib members. As such, as the gaps between neighboring elongated rib members close as wearable input device 101 moves from a flat mode of operation to a curved mode of operation the overlapping scales are able to accommodate the changing length of the bottom of wearable input device 101 as the wearable input device 101 moves from the flat mode of operation to a curved mode of operation.

The bottom flexible support may slide between the holes and the rivets. Because the bottom flexible support is not attached to the elongated rib members, the bottom flexible support may also accommodate the changing length of the bottom of wearable input device 101 as wearable input device moves from the flat mode of operation to the curved mode of operation.

The top flexible support, the bottom flexible support, and the plurality of overlapping scales may be comprised of thin sheets of a metal, such as steel. In alternative embodiments, the flexible supports and/or scales may be comprised of any material that is suitably flexible, strong, and durable. In some embodiments, one or more of the top flexible support, the bottom flexible support, and the overlapping scales may be made from plastic.

The top flexible support 24 includes a left side row of holes and a right side row of holes that extend along a longitudinal axis of member 105. Each hole in the top flexible support may be complementary to a hole in the top face of an elongated rib member. The top flexible support may be attached to an elongated rib member at each pair of complementary holes. For example, a fastener, such as a rivet, may be used to attach the top flexible support to the elongated rib members at the complementary holes. In some embodiments, the top flexible support may be attached to elongated rib members via another suitable mechanism, such as via heat stakes and/or screws. Attaching each elongated rib member to the top flexible support at two separate locations may help limit the elongated rib members from twisting relative to one another.

An elongated rib member may include one or more projections configured to mate with complementary cavities in a neighboring elongated rib member. For example, FIG. 6 shows an elongated rib member 22b that includes a left projection 70a and a right projection. The projections are configured to mate with complementary left cavity 72a and right cavity 72b of neighboring elongated rib member 22c. The mating of the projections into complementary cavities may further help limit the elongated rib members from twisting relative to one another. The cavities may be sized so as to accommodate more complete entry of the projections as wearable input device 101 moves from the flat mode of operation to a curved mode of operation.

Turning back to FIG. 5A, member 105 includes latch 80 in an embodiment. Latch 80 may be configured to provide a straightening force to bias the plurality of elongated rib members in the flat mode of operation when the plurality of elongated rib members are in the flat mode of operation. Latch 80 may also be configured to provide a bending force to bias the plurality of elongated rib members in the curved mode of operation when the plurality of elongated rib members is in the curved mode of operation. In other words, when the wearable input device 101 is in the flat operation, latch 80 may work to prevent wearable input device 101 from being moved into a curved mode of operation; and when the wearable input device 101 is in the curved mode of operation, latch 80 may work to prevent wearable input device 101 from being moved into the flat mode of operation. In this way, wearable input device 101 is less likely to accidentally be moved from the flat mode of operation to the curved mode of operation or vice versa. A strength of the biasing forces provided by the latch may be set so as to prevent accidental movement from one mode of operation to the other while at the same time allowing purposeful movement from one mode of operation to the other. In some embodiments, the biasing forces may be unequal, such that the wearable input device may be moved from the flat mode of operation to a curved mode of operation relatively easier than from the curved mode of operation to the flat mode of operation, for example.

Latch 80 may be located within one or more elongated rib members and/or other portions of wearable input device 101.

Latch 80 is a magnetic latch in an embodiment. While a magnetic latch is provided as a nonlimiting example of a suitable latch, it is to be understood that other latches may be used without departing from the scope of this disclosure. In the illustrated embodiment, latch 80 includes a front magnetic partner 84 and a rear magnetic partner 86 that are each attached to top flexible support 24. Latch 80 also includes an intermediate magnetic partner 88 attached to bottom flexible support 26. Intermediate magnetic partner 88 is disposed between front magnetic partner 84 and rear magnetic partner 86.

In general, the front magnetic partner and the rear magnetic partner are made of one or more materials that are magnetically attracted to the one or more materials from which the intermediate magnetic partner is made. As one example, the front magnetic partner and the rear magnetic partner may be iron that is not permanently magnetic, and the intermediate magnetic partner may be a permanent magnet (e.g., ferromagnetic iron). As another example, the front magnetic partner and the rear magnetic partner may be a permanent magnet (e.g., ferromagnetic iron), and the intermediate magnetic partner may be iron that is not permanently magnetic. It is to be understood that any combination of magnetically attractive partners may be used.

When wearable input device 101 is in a flat mode of operation, front magnetic partner 84 and intermediate magnetic partner 88 magnetically bias the plurality of elongated rib members in a flat mode of operation. In particular, front magnetic partner 84 and intermediate magnetic partner 88 magnetically attract one another. When wearable input device 101 moves from a flat mode of operation to a curved mode of operation, intermediate magnetic partner 88 moves away from front magnetic partner 84 towards rear magnetic partner 86 because the inner radius of the bottom flexible support is less than the outer radius of the top flexible support. As such, the magnetic force between front magnetic partner 84 and intermediate magnetic partner 88 works to prevent wearable input device 101 from moving from a flat mode of operation to a curved mode of operation.

When wearable input device 101 is in a curved mode of operation, rear magnetic partner 86 and intermediate magnetic partner 88 magnetically bias the plurality of elongated rib members in a curved mode of operation. In particular, rear magnetic partner 86 and intermediate magnetic partner 88 magnetically attract one another. When wearable input device 101 moves from a curved mode of operation to a flat mode of operation, intermediate magnetic partner 88 moves away from rear magnetic partner 86 towards front magnetic partner 84 because the inner radius of the bottom flexible support is less than the outer radius of the top flexible support. As such, the magnetic force between rear magnetic partner 86 and intermediate magnetic partner 88 works to prevent wearable input device 101 from moving from a curved mode of operation to a flat mode of operation.

FIG. 7 is a front view of a wearable input device 101 in a flat mode of operation having a touch surface 104. In an embodiment, touch surface has touch sensors 601a-d positioned at the four corners of touch surface 104 in order to detect a location that has been touched by user 100. Touch sensors 601a-d outputs touch information to electronics components 107.

In an embodiment, electronics components 107 are positioned on the back of wearable input device 101 as illustrated in FIG. 8. In alternate embodiments, electronic components 107 may be dispersed throughout wearable input device 101. For example, one or more biometric sensors 607 may be dispersed at optimal positions to read biometric information from user 100 when wearable input device 101 is positioned adjacent to skin of user 100.

In an embodiment, electronic components 107 include a few electronic components and most computational tasks related to user inputs are performed externally. For example, electronic components 107 may includes a wired or wireless transmitter 602, memory 608 to store machine or processor readable instructions including a software driver 608a to read inputs from sensors 601a-d and provide an output signal to a transmitter 602 that represents touch inputs by user 100.

In embodiments, transmitter 602 may provide one or more various types of wireless and/or wired signal. For example, transmitter 602 may transmit various types of wireless signals including WiFi, Bluetooth, infrared, infrared personal area network, radio frequency Identification (RFID), wireless Universal Serial Bus (WUSB), cellular, 3G, 4G or other types of wireless signals.

In an alternate embodiment, electronic components 107 include numerous components and/or perform computational extensive tasks. In an embodiment, electronic components 107 are positioned on a flexible substrate having a plurality of electronic connections including wires or traces to transfer electronic signals between electronic components. In an embodiment, one or more electronic components 107 may be included in a single packaged chip or system-on-a-chip (SoC).

In an embodiment, electronic components 107 include one or more processors 603. Processor 603 may comprise a controller, central processing unit (CPU), graphics-processing unit (GPU), digital signal processor (DSP) and/or a field programmable gate array (FPGA). In an embodiment, memory 610 includes processor readable instructions to operate wearable input device 101. In embodiments, memory 610 includes a variety of different types of volatile as well as non-volatile memory as described herein.

In an embodiment, power supply 604 provides power or a predetermined voltage to one or more electronic components in electronic components 107 as well as touch surface 104. In an embodiment, power supply 604 provides power to one or more electronic components in electronic components 107 in response to a switch being toggled on wearable input device 101 by user 100.

In an embodiment, electronic components 107 includes inertial sensing unit 605 including one or more inertial sensors to sense an orientation of wearable input device 101, and a location sensing unit 606 to sense a location of wearable input device 101. In an embodiment, inertial sensing unit 605 includes a three axis accelerometer and a three axis magnetometer, that determines orientation changes of wearable input device 101. An orientation of wearable input device 101 may include a landscape, portrait, one hand, two-handed orientation, curved or flat orientation. Location sensing unit 606 may include one or more location or proximity sensors, some examples of which are a global positioning system (GPS) transceiver, an infrared (IR) transceiver, or a radio frequency transceiver for processing RFID data.

In an embodiment, one or more electronic components in electronic components 107 and/or sensors may include an analog interface that produces or converts an analog signal, or both produces and converts an analog signal, for its respective component or sensor. For example, inertial sensing unit 605, location sensing unit 606, touch sensors 601a-d and biometric sensors 607 may include analog interfaces that convert analog signals to digital signals.

In embodiments, one or more biometric sensors 607 may include a variety of different types of biometric sensors. For example, biometric sensors may include heart rate monitors or sensors, blood/oxygen sensors, accelerometers, thermometers or other types of biometric sensors that obtain biometric information from user 100. In an embodiment, a blood/oxygen sensor includes a pulse oximetry sensor that measures a saturation of user's hemoglobin.

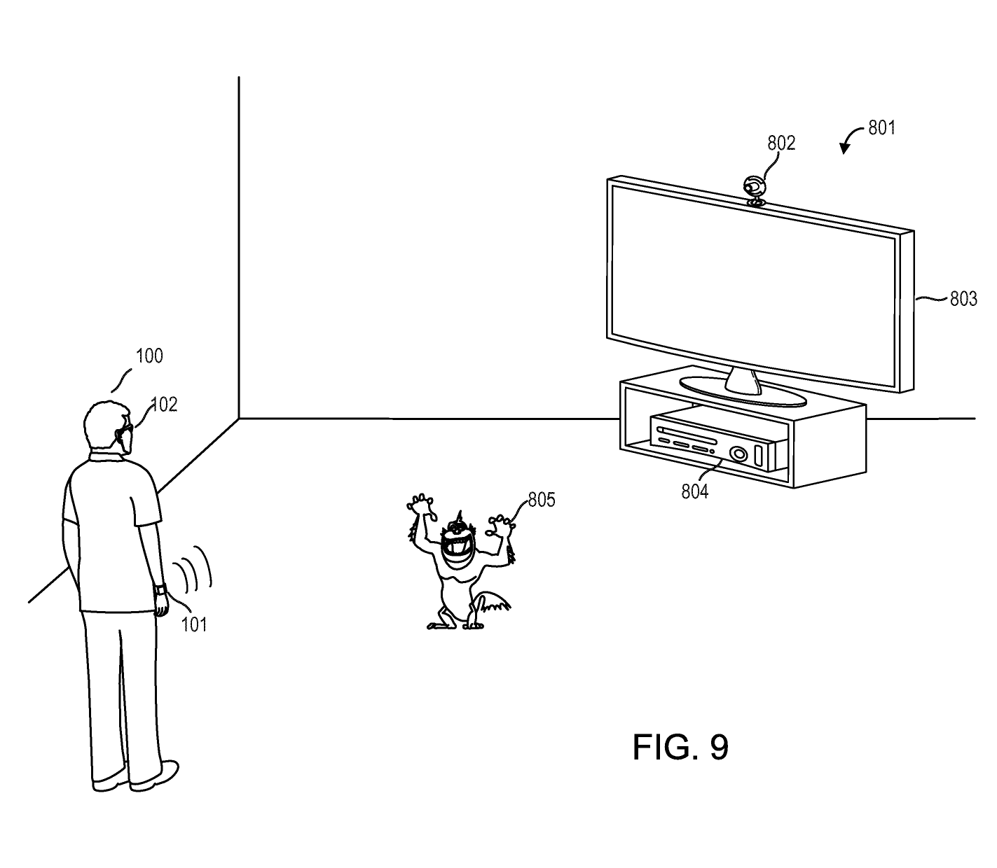

FIG. 9 illustrates a user 100 having a wearable input device 101 in an AR system 801. FIG. 9 depicts one embodiment of a field of view as seen by user 100 wearing a HMD 102. As depicted, user 100 may see within their field of view both real objects and virtual objects. The real objects may include AR system 801 (e.g., comprising a portion of an entertainment system). The virtual objects may include a virtual pet monster 805. As the virtual pet monster 805 is displayed or overlaid over the real-world environment as perceived through the see-through lenses of HMD 102, user 100 may perceive that a virtual pet monster 805 exists within the real-world environment. The virtual pet monster 805 may be generated by a HMD 102 or by way of AR system 801, in which case HMD 102 may receive virtual object information associated with virtual pet monster 805 and rendered locally prior to display. In one embodiment, information associated with the virtual pet monster 805 is only provided when HMD 102 is within a particular distance (e.g., 20 feet) of the AR system 801. In some embodiments, virtual pet monster 805 may comprise a form of advertising, whereby the virtual pet monster 805 is perceived to exist near a storefront whenever an HMD 102 is within a particular distance of the storefront. In an alternate embodiment, virtual pet monster 805 appears to user 100 when user 100 touches a MonsterPet key on wearable user input device 101.

In alternate embodiments, other virtual objects or virtual locations may be provided by AR system 801. For example, when user 100 picks up a book, virtual text describing reviews of the book may be positioned next to the book. In other embodiments, a virtual location at a previous time period may be displayed or provided to user 100. In an embodiment, a user 100 may select a virtual location provided by AR system 801 by touching wearable input device 101 at the defined area, such as an area defined by a “AR 100” key.

The AR system 801 may include a computing environment 804, a capture device 802, and a display 803, all in communication with each other. Computing environment 804 may include one or more processors as described herein. Capture device 802 may include a color or depth sensing camera that may be used to visually monitor one or more targets including humans and one or more other real objects within a particular environment. In one example, capture device 802 may comprise an RGB or depth camera and computing environment 804 may comprise a set-top box or gaming console. AR system 801 may support multiple users and wearable input devices.

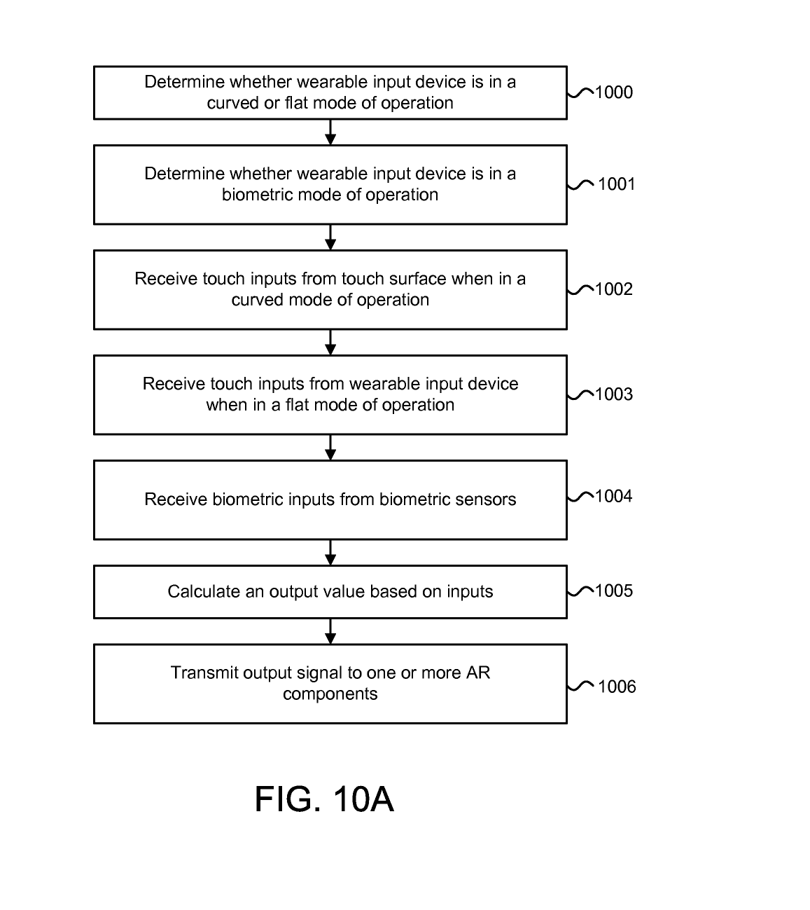

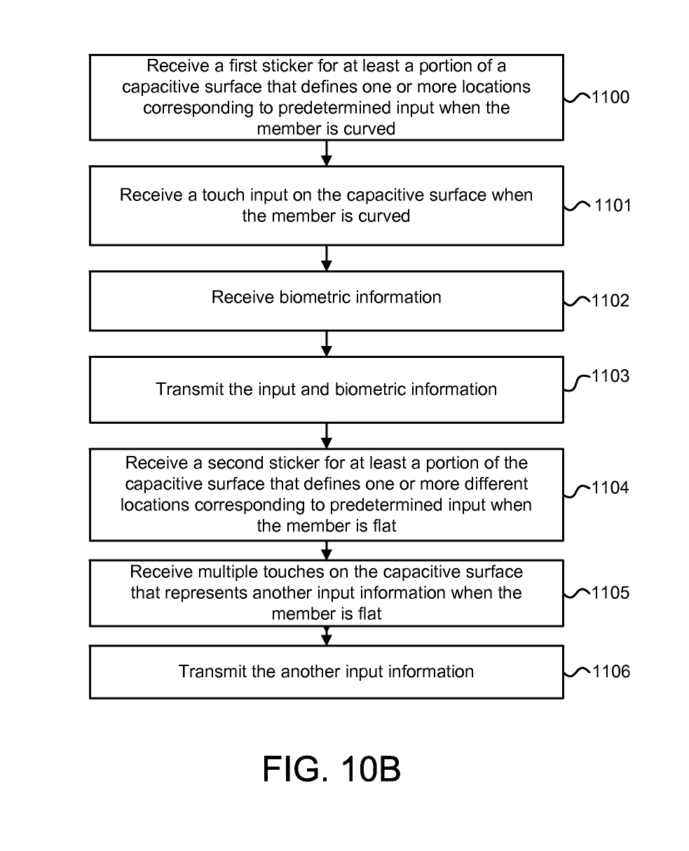

FIGS. 10A-B are flow charts illustrating methods of operating a wearable input device. In embodiments, steps illustrated in FIGS. 10A-B represent the operation of hardware (e.g., processor, circuits), software (e.g., drivers, machine/processor executable instructions), or a user, singly or in combination. As one of ordinary skill in the art would understand, embodiments may include less or more steps shown.

Step 1000 illustrates determining whether a wearable input device is in a curved mode of operation or in a flat mode of operation. In an embodiment, one or more inertial sensing units 605 in electronic components 107 outputs a signal indicating an orientation. Processor 603 then may execute processor readable instructions in memory 610 to determine whether a wearable input device is in a curved or flat mode of operation.

Step 1001 illustrates determining whether a wearable input device is in a biometric mode of operation. In embodiments, a wearable input device may also be in a biometric mode of operation (receiving valid biometric information) in either a curved or flat mode of operation. In an embodiment, a biometric mode of operation does not occur when a wearable input device is in a flat mode of operation because biometric sensors are not in close proximity to skin of a user, such as a wrist. In an embodiment, biometric inputs are compared to biometric threshold values to determine whether a biometric mode of operation is available. In an embodiment, biometric threshold values stored in memory 610 are compared to biometric inputs by processor 603 and executable processor readable instructions stored in memory 610 to determine whether a biometric mode of operation is available. Biometric sensors may not be able to obtain valid biometric information because wearable input device is not in an orientation or fitted to a user such that valid sensor inputs may be obtained.

Step 1002 illustrates receiving touch inputs from a touch surface when a wearable input device is in a curved mode of operation. Step 1003 illustrates receiving touch inputs from a touch surface when a wearable input device is in a flat mode of operation. In embodiments, different key layouts may be used for the curved mode of operation and flat mode of operation. For example in a flat mode of operation, a touch surface may have many more locations that correspond to characters so that a wearable input device may be more easily used in complex two handed operations that may need multiple touches, such as forming a text message. In a curved mode of operation, a different key layout having a few larger keys or locations may be used. For example, a large key area may be identified for a favorite AR user experience or image of a user. As described herein, different key layout stickers may be adhered to a touch surface to let a user know where to touch for a particular input in different modes of operation.

Step 1004 illustrates receiving biometric inputs from biometric sensors. In an embodiment, one or more biometric sensors 607 output signals representing biometric input to processor 603 executing processor readable instructions stored in memory 610.

Step 1005 illustrates a wearable user input device performing a calculation based on the received inputs. Processor 603 executing processor readable instructions stored in memory 610 may determine or calculate a possible AR experience that a user may want to experience based on touch inputs and biometric inputs, such as heart rate. For example, if a user requests a AR experience through touch inputs that may cause excitement/fear and a heart rate exceeds a predetermined value, a wearable input device may output a calculated request for a less exciting/fearful AR experience.

In alternate embodiments, no calculations are performed in step 1005 and control proceeds to step 1006 where received inputs are transmitted to one or more AR components as described herein. In embodiments, transmitter 602 outputs a wireless or wired signal that represents the user touch and biometric inputs to an AR component, such as computing system(s) 1512 as described herein.

FIG. 10B illustrates another method of operating a wearable input device. In step 1100, a first sticker defining one or more locations corresponding to predetermined input may be received by or attached to at least a portion of a capacitive surface, such as capacitive surface 104 illustrated in FIGS. 2-3. The first sticker may be selected and attached prior to when the wearable input device is to be worn or while worn by a user. The first sticker may be coupled to the capacitive surface by adhesive. The first sticker may be customized and/or may be replaced with other stickers when the wearable input device is in other modes of operation, such as a flat mode of operation.

In step 1101, a capacitive surface receives at least one touch that represents a character input and/or gesture in an embodiment. For example, a user may touch a portion of the first sticker (attached to the capacitive surface) that corresponds to a desired character input or operation of an AR system.

In step 1102, biometric information from biometric sensors as described herein may be measured and received by the wearable input device. The biometric information may be, but not limited to, heart rate and blood information from a user wearing the wearable input device.

In step 1103, the input and biometric information may be transmitted. For example, the information may be transmitted by one or more wireless signals to one or more computing systems in an AR system.

Step 1104 illustrates receiving or attaching a second sticker that defines one or more different locations corresponding to predetermined input while the wearable input device is in a flat mode of operation. In an embodiment, the second sticker is adhered to the first sticker. In an alternate embodiment, the second sticker is adhered to at least a portion of the capacitive surface after the first sticker is removed. In an embodiment, the second sticker has a more extensive character layout so more complex multi-hand operations may be performed, such as composing and sending a text message.

In step 1105 multiple touches are received on the second sticker (attached to the capacitive surface) that represents another input information when the wearable input device is in a flat mode of operation. For example, a user may have multiple touches in forming a text message.

Step 1106 then illustrates transmitting another input information. In an embodiment another information may be transmitted by one or more wireless signals to one or more computing systems in an AR system.

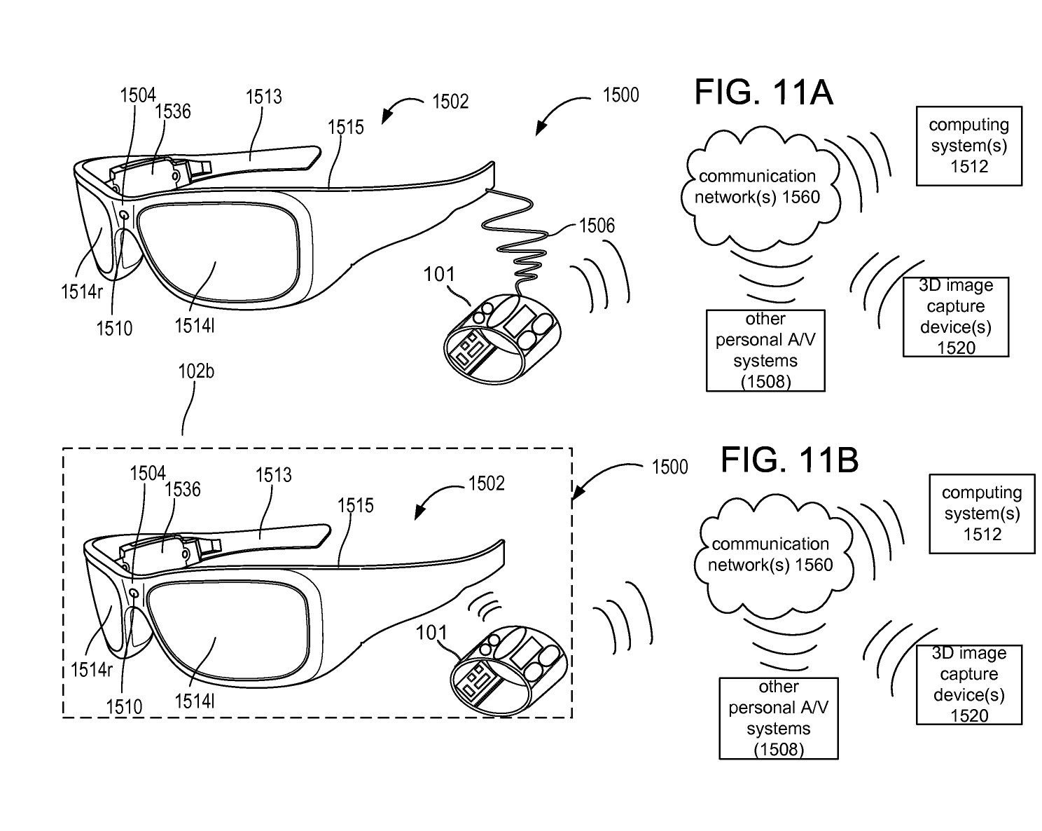

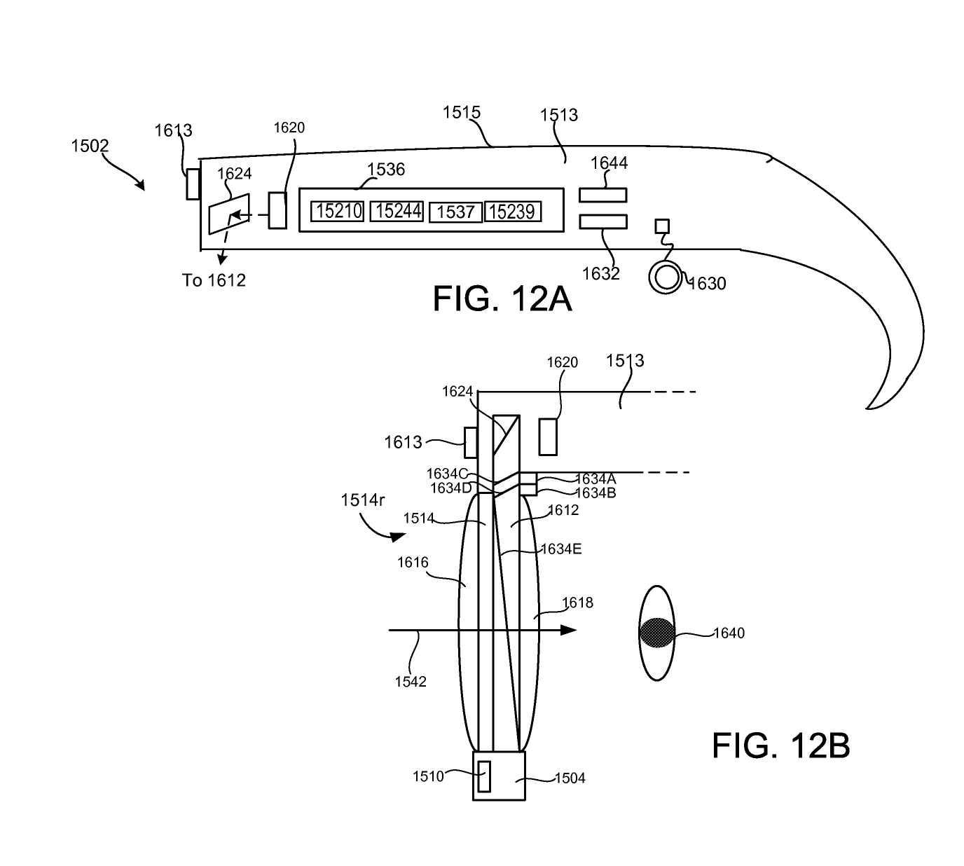

FIG. 11A is a block diagram depicting example components of an embodiment of a personal audiovisual (A/V) apparatus that may receive inputs from a wearable input device 101 as described herein. Personal A/V apparatus 1500 includes an optical see-through, AR display device as a near-eye, AR display device or HMD 1502 in communication with wearable input device 101 via a wire 1506 in this example or wirelessly in other examples. In this embodiment, HMD 1502 is in the shape of eyeglasses having a frame 1515 with temple arms as described herein, with a display optical system 1514, 1514r and 1514l, for each eye in which image data is projected into a user's eye to generate a display of the image data while a user also sees through the display optical systems 1514 for an actual direct view of the real world.

Each display optical system 1514 is also referred to as a see-through display, and the two display optical systems 1514 together may also be referred to as a see-through, meaning optical see-through, AR display 1514.

Frame 1515 provides a support structure for holding elements of the apparatus in place as well as a conduit for electrical connections. In this embodiment, frame 1515 provides a convenient eyeglass frame as support for the elements of the apparatus discussed further below. The frame 1515 includes a nose bridge 1504 with a microphone 1510 for recording sounds and transmitting audio data to control circuitry 1536. In this example, the temple arm 1513 is illustrated as including control circuitry 1536 for the HMD 1502.

As illustrated in FIGS. 12A and 12B, an image generation unit 1620 is included on each temple arm 1513 in this embodiment as well. Also illustrated in FIGS. 12A and 12B are outward facing capture devices 1613, e.g. cameras, for recording digital image data such as still images, videos or both, and transmitting the visual recordings to the control circuitry 1536 which may in turn send the captured image data to the wearable input device 101 which may also send the data to one or more computer systems 1512 or to another personal A/V apparatus over one or more communication networks 1560.

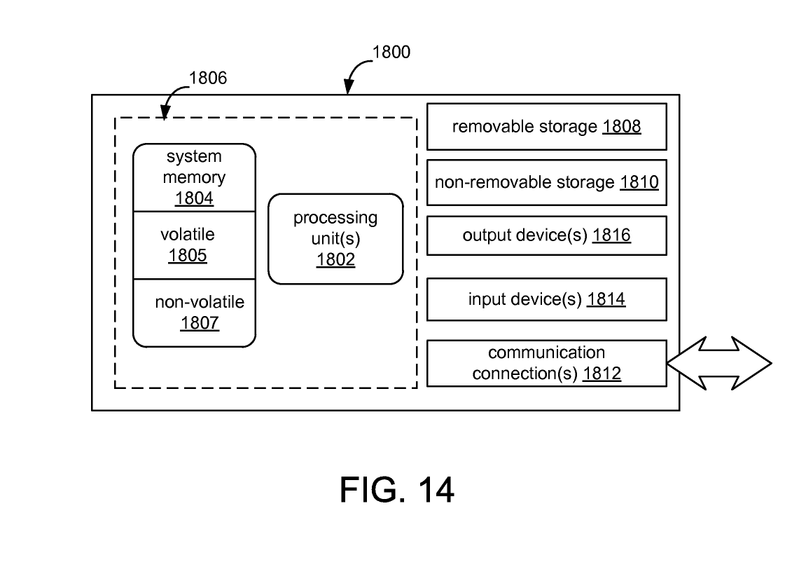

Wearable input device 101 may communicate wired and/or wirelessly (e.g., WiFi, Bluetooth, infrared, an infrared personal area network, RFID transmission, WUSB, cellular, 3G, 4G or other wireless communication means) over one or more communication networks 1560 to one or more computer systems 1512 whether located nearby or at a remote location, other personal A/V apparatus 1508 in a location or environment. In other embodiments, wearable input device 101 communicates with HMD 1502 and/or communication network(s) by wireless signals as in FIG. 11B. An example of hardware components of a computer system 1512 is also shown in FIG. 14. The scale and number of components may vary considerably for different embodiments of the computer system 1512.

An application may be executing on a computer system 1512 which interacts with or performs processing for an application executing on one or more processors in the personal A/V apparatus 1500. For example, a 3D mapping application may be executing on the one or more computers systems 12 and the user's personal A/V apparatus 1500.

In the illustrated embodiments of FIGS. 11A and 11B, the one or more computer system 1512 and the personal A/V apparatus 1500 also have network access to one or more 3D image capture devices 1520 which may be, for example one or more cameras that visually monitor one or more users and the surrounding space such that gestures and movements performed by the one or more users, as well as the structure of the surrounding space including surfaces and objects, may be captured, analyzed, and tracked. Image data, and depth data if captured, of the one or more 3D capture devices 1520 may supplement data captured by one or more capture devices 1613 on the near-eye, AR HMD 1502 of the personal A/V apparatus 1500 and other personal A/V apparatus 1508 in a location for 3D mapping, gesture recognition, object recognition, resource tracking, and other functions as discussed further below.

FIG. 12A is a side view of an eyeglass temple arm 1513 of a frame in an embodiment of the personal audiovisual (A/V) apparatus having an optical see-through, AR display embodied as eyeglasses providing support for hardware and software components. At the front of frame 1515 is depicted one of at least two physical environment facing capture devices 1613, e.g. cameras, that can capture image data like video and still images, typically in color, of the real world to map real objects in the display field of view of the see-through display, and hence, in the field of view of the user. In some examples, the capture devices 1613 may also be depth sensitive, for example, they may be depth sensitive cameras which transmit and detect infrared light from which depth data may be determined.

Control circuitry 1536 provide various electronics that support the other components of HMD 1502. In this example, the right temple arm 1513 includes control circuitry 1536 for HMD 1502 which includes a processing unit 15210, a memory 15244 accessible to the processing unit 15210 for storing processor readable instructions and data, a wireless interface 1537 communicatively coupled to the processing unit 15210, and a power supply 15239 providing power for the components of the control circuitry 1536 and the other components of HMD 1502 like the cameras 1613, the microphone 1510 and the sensor units discussed below. The processing unit 15210 may comprise one or more processors that may include a controller, CPU, GPU and/or FPGA.

Inside, or mounted to temple arm 1502, are an earphone of a set of earphones 1630, an inertial sensing unit 1632 including one or more inertial sensors, and a location sensing unit 1644 including one or more location or proximity sensors, some examples of which are a GPS transceiver, an IR transceiver, or a radio frequency transceiver for processing RFID data.

In this embodiment, each of the devices processing an analog signal in its operation include control circuitry which interfaces digitally with the digital processing unit 15210 and memory 15244 and which produces or converts analog signals, or both produces and converts analog signals, for its respective device. Some examples of devices which process analog signals are the sensing units 1644, 1632, and earphones 1630 as well as the microphone 1510, capture devices 1613 and a respective IR illuminator 1634A, and a respective IR detector or camera 1634B for each eye's display optical system 154l, 154r discussed below.

Mounted to or inside temple arm 1515 is an image source or image generation unit 1620 which produces visible light representing images. The image generation unit 1620 can display a virtual object to appear at a designated depth location in the display field of view to provide a realistic, in-focus three dimensional display of a virtual object which can interact with one or more real objects.

In some embodiments, the image generation unit 1620 includes a microdisplay for projecting images of one or more virtual objects and coupling optics like a lens system for directing images from the microdisplay to a reflecting surface or element 1624. The reflecting surface or element 1624 directs the light from the image generation unit 1620 into a light guide optical element 1612, which directs the light representing the image into the user's eye.

FIG. 12B is a top view of an embodiment of one side of an optical see-through, near-eye, AR display device including a display optical system 1514. A portion of the frame 1515 of the HMD 1502 will surround a display optical system 1514 for providing support and making electrical connections. In order to show the components of the display optical system 1514, in this case 1514r for the right eye system, in HMD 1502, a portion of the frame 1515 surrounding the display optical system is not depicted.

In the illustrated embodiment, the display optical system 1514 is an integrated eye tracking and display system. The system embodiment includes an opacity filter 1514 for enhancing contrast of virtual imagery, which is behind and aligned with optional see-through lens 1616 in this example, light guide optical element 1612 for projecting image data from the image generation unit 1620 is behind and aligned with opacity filter 1514, and optional see-through lens 1618 is behind and aligned with light guide optical element 1612.

Light guide optical element 1612 transmits light from image generation unit 1620 to the eye 1640 of a user wearing HMD 1502. Light guide optical element 1612 also allows light from in front of HMD 1502 to be received through light guide optical element 1612 by eye 1640, as depicted by an arrow representing an optical axis 1542 of the display optical system 1514r, thereby allowing a user to have an actual direct view of the space in front of HMD 1502 in addition to receiving a virtual image from image generation unit 1620. Thus, the walls of light guide optical element 1612 are see-through. In this embodiment, light guide optical element 1612 is a planar waveguide. A representative reflecting element 1634E represents the one or more optical elements like mirrors, gratings, and other optical elements which direct visible light representing an image from the planar waveguide towards the user eye 1640.

Infrared illumination and reflections, also traverse the planar waveguide for an eye tracking system 1634 for tracking the position and movement of the user's eye, typically the user's pupil. Eye movements may also include blinks. The tracked eye data may be used for applications such as gaze detection, blink command detection and gathering biometric information indicating a personal state of being for the user. The eye tracking system 1634 comprises an eye tracking IR illumination source 1634A (an infrared light emitting diode (LED) or a laser (e.g. VCSEL)) and an eye tracking IR sensor 1634B (e.g. IR camera, arrangement of IR photo detectors, or an IR position sensitive detector (PSD) for tracking glint positions). In this embodiment, representative reflecting element 1634E also implements bidirectional IR filtering which directs IR illumination towards the eye 1640, preferably centered about the optical axis 1542 and receives IR reflections from the user eye 1640. A wavelength selective filter 1634C passes through visible spectrum light from the reflecting surface or element 1624 and directs the infrared wavelength illumination from the eye tracking illumination source 1634A into the planar waveguide. Wavelength selective filter 1634D passes the visible light and the infrared illumination in an optical path direction heading towards the nose bridge 1504. Wavelength selective filter 1634D directs infrared radiation from the waveguide including infrared reflections of the user eye 1640, preferably including reflections captured about the optical axis 1542, out of the light guide optical element 1612 embodied as a waveguide to the IR sensor 1634B.

Opacity filter 1514, which is aligned with light guide optical element 112, selectively blocks natural light from passing through light guide optical element 1612 for enhancing contrast of virtual imagery. The opacity filter assists the image of a virtual object to appear more realistic and represent a full range of colors and intensities. In this embodiment, electrical control circuitry for the opacity filter, not shown, receives instructions from the control circuitry 1536 via electrical connections routed through the frame.

Again, FIGS. 12A and 12B show half of HMD 1502. For the illustrated embodiment, a full HMD 1502 may include another display optical system 1514 and components described herein.

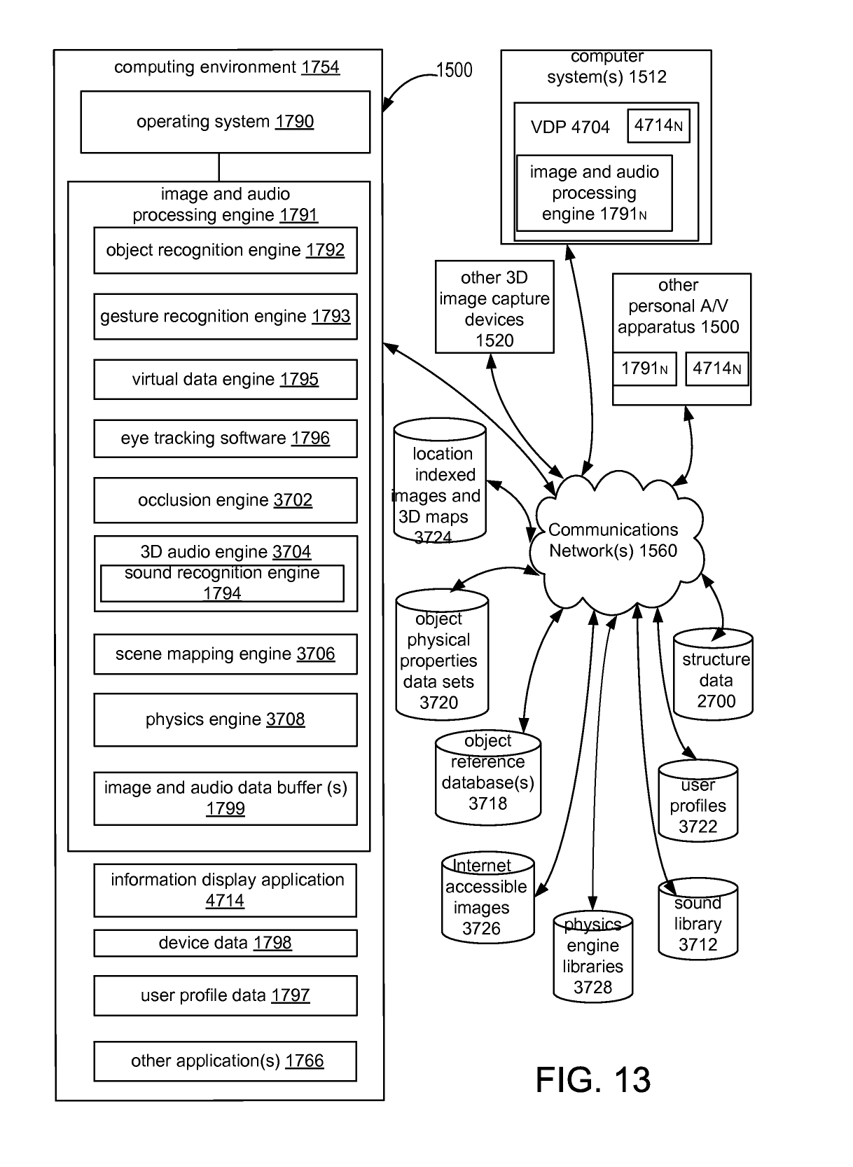

FIG. 13 is a block diagram of a system from a software perspective for representing a physical location at a previous time period with three dimensional (3D) virtual data being displayed by a near-eye, AR display of a personal audiovisual (A/V) apparatus. FIG. 13 illustrates a computing environment embodiment 1754 from a software perspective which may be implemented by a system like physical A/V apparatus 1500, one or more remote computer systems 1512 in communication with one or more physical A/V apparatus or a combination of these. Additionally, physical A/V apparatus can communicate with other physical A/V apparatus for sharing data and processing resources. Network connectivity allows leveraging of available computing resources. An information display application 4714 may be executing on one or more processors of the personal A/V apparatus 1500. In the illustrated embodiment, a virtual data provider system 4704 executing on a remote computer system 1512 can also be executing a version of the information display application 4714 as well as other personal A/V apparatus 1500 with which it is in communication. As shown in the embodiment of FIG. 13, the software components of a computing environment 1754 comprise an image and audio processing engine 1791 in communication with an operating system 1790. Image and audio processing engine 1791 processes image data (e.g. moving data like video or still), and audio data in order to support applications executing for a HMD system like a physical A/V apparatus 1500 including a near-eye, AR display. Image and audio processing engine 1791 includes object recognition engine 1792, gesture recognition engine 1793, virtual data engine 1795, eye tracking software 1796 if eye tracking is in use, an occlusion engine 3702, a 3D positional audio engine 3704 with a sound recognition engine 1794, a scene mapping engine 3706, and a physics engine 3708 which may communicate with each other.

The computing environment 1754 also stores data in image and audio data buffer(s) 1799. The buffers provide memory for receiving image data captured from the outward facing capture devices 1613, image data captured by other capture devices if available, image data from an eye tracking camera of an eye tracking system 1634 if used, buffers for holding image data of virtual objects to be displayed by the image generation units 1620, and buffers for both input and output audio data like sounds captured from the user via microphone 1510 and sound effects for an application from the 3D audio engine 3704 to be output to the user via audio output devices like earphones 1630.

Image and audio processing engine 1791 processes image data, depth data and audio data received from one or more capture devices which may be available in a location. Image and depth information may come from the outward facing capture devices 1613 captured as the user moves his head or body and additionally from other physical A/V apparatus 1500, other 3D image capture devices 1520 in the location and image data stores like location indexed images and maps 3724.

The individual engines and data stores depicted in FIG. 13 are described in more detail below, but first an overview of the data and functions they provide as a supporting platform is described from the perspective of an application like an information display application 4714 which provides virtual data associated with a physical location. An information display application 4714 executing in the near-eye, AR physical A/V apparatus 1500 or executing remotely on a computer system 1512 for the physical A/V apparatus 1500 leverages the various engines of the image and audio processing engine 1791 for implementing its one or more functions by sending requests identifying data for processing and receiving notification of data updates. For example, notifications from the scene mapping engine 3706 identify the positions of virtual and real objects at least in the display field of view. The information display application 4714 identifies data to the virtual data engine 1795 for generating the structure and physical properties of an object for display. The information display application 4714 may supply and identify a physics model for each virtual object generated for its application to the physics engine 3708, or the physics engine 3708 may generate a physics model based on an object physical properties data set 3720 for the object.

The operating system 1790 makes available to applications which gestures the gesture recognition engine 1793 has identified, which words or sounds the sound recognition engine 1794 has identified, the positions of objects from the scene mapping engine 3706 as described above, and eye data such as a position of a pupil or an eye movement like a blink sequence detected from the eye tracking software 1796. A sound to be played for the user in accordance with the information display application 4714 can be uploaded to a sound library 3712 and identified to the 3D audio engine 3704 with data identifying from which direction or position to make the sound seem to come from. The device data 1798 makes available to the information display application 4714 location data, head position data, data identifying an orientation with respect to the ground and other data from sensing units of the HMD 1502.

The scene mapping engine 3706 is first described. A 3D mapping of the display field of view of the AR display can be determined by the scene mapping engine 3706 based on captured image data and depth data, either derived from the captured image data or captured as well. The 3D mapping includes 3D space positions or position volumes for objects.

A depth map representing captured image data and depth data from outward facing capture devices 1613 can be used as a 3D mapping of a display field of view of a near-eye AR display. A view dependent coordinate system may be used for the mapping of the display field of view approximating a user perspective. The captured data may be time tracked based on capture time for tracking motion of real objects. Virtual objects can be inserted into the depth map under control of an application like information display application 4714. Mapping what is around the user in the user's environment can be aided with sensor data. Data from an orientation sensing unit 1632, e.g. a three axis accelerometer and a three axis magnetometer, determines position changes of the user's head and correlation of those head position changes with changes in the image and depth data from the front facing capture devices 1613 can identify positions of objects relative to one another and at what subset of an environment or location a user is looking.

In some embodiments, a scene mapping engine 3706 executing on one or more network accessible computer systems 1512 updates a centrally stored 3D mapping of a location and apparatus 1500 download updates and determine changes in objects in their respective display fields of views based on the map updates. Image and depth data from multiple perspectives can be received in real time from other 3D image capture devices 1520 under control of one or more network accessible computer systems 1512 or from one or more physical A/V apparatus 1500 in the location. Overlapping subject matter in the depth images taken from multiple perspectives may be correlated based on a view independent coordinate system, and the image content combined for creating the volumetric or 3D mapping of a location (e.g. an x, y, z representation of a room, a store space, or a geofenced area). Additionally, the scene mapping engine 3706 can correlate the received image data based on capture times for the data in order to track changes of objects and lighting and shadow in the location in real time.

The registration and alignment of images allows the scene mapping engine to be able to compare and integrate real-world objects, landmarks, or other features extracted from the different images into a unified 3-D map associated with the real-world location.

When a user enters a location or an environment within a location, the scene mapping engine 3706 may first search for a pre-generated 3D map identifying 3D space positions and identification data of objects stored locally or accessible from another physical A/V apparatus 1500 or a network accessible computer system 1512. The pre-generated map may include stationary objects. The pre-generated map may also include objects moving in real time and current light and shadow conditions if the map is presently being updated by another scene mapping engine 3706 executing on another computer system 1512 or apparatus 1500. For example, a pre-generated map indicating positions, identification data and physical properties of stationary objects in a user's living room derived from image and depth data from previous HMD sessions can be retrieved from memory. Additionally, identification data including physical properties for objects which tend to enter the location can be preloaded for faster recognition. A pre-generated map may also store physics models for objects as discussed below. A pre-generated map may be stored in a network accessible data store like location indexed images and 3D maps 3724.

The location may be identified by location data which may be used as an index to search in location indexed image and pre-generated 3D maps 3724 or in Internet accessible images 3726 for a map or image related data which may be used to generate a map. For example, location data such as GPS data from a GPS transceiver of the location sensing unit 1644 on a HMD 1502 may identify the location of the user. In another example, a relative position of one or more objects in image data from the outward facing capture devices 1613 of the user's physical A/V apparatus 1500 can be determined with respect to one or more GPS tracked objects in the location from which other relative positions of real and virtual objects can be identified. Additionally, an IP address of a WiFi hotspot or cellular station to which the physical A/V apparatus 1500 has a connection can identify a location. Additionally, identifier tokens may be exchanged between physical A/V apparatus 1500 via infra-red, Bluetooth or WUSB. The range of the infra-red, WUSB or Bluetooth signal can act as a predefined distance for determining proximity of another user. Maps and map updates, or at least object identification data may be exchanged between physical A/V apparatus via infra-red, Bluetooth or WUSB as the range of the signal allows.

The scene mapping engine 3706 identifies the position and tracks the movement of real and virtual objects in the volumetric space based on communications with the object recognition engine 1792 of the image and audio processing engine 1791 and one or more executing applications generating virtual objects.

The object recognition engine 1792 of the image and audio processing engine 1791 detects, tracks and identifies real objects in the display field of view and the 3D environment of the user based on captured image data and captured depth data if available or determined depth positions from stereopsis. The object recognition engine 1792 distinguishes real objects from each other by marking object boundaries and comparing the object boundaries with structural data. One example of marking object boundaries is detecting edges within detected or derived depth data and image data and connecting the edges. Besides identifying the type of object, an orientation of an identified object may be detected based on the comparison with stored structure data 2700, object reference data sets 3718 or both. One or more databases of structure data 2700 accessible over one or more communication networks 1560 may include structural information about objects. As in other image processing applications, a person can be a type of object, so an example of structure data is a stored skeletal model of a human which may be referenced to help recognize body parts. Structure data 2700 may also include structural information regarding one or more inanimate objects in order to help recognize the one or more inanimate objects, some examples of which are furniture, sporting equipment, automobiles and the like.

The structure data 2700 may store structural information as image data or use image data as references for pattern recognition. The image data may also be used for facial recognition. The object recognition engine 1792 may also perform facial and pattern recognition on image data of the objects based on stored image data from other sources as well like user profile data 1797 of the user, other users profile data 3722 which are permission and network accessible, location indexed images and 3D maps 3724 and Internet accessible images 3726.

FIG. 14 is a block diagram of one embodiment of a computing system that can be used to implement one or more network accessible computer systems 1512 which may host at least some of the software components of computing environment 1754 or other elements depicted in FIG. 13. With reference to FIG. 14, an exemplary system includes a computing device, such as computing device 1800. In its most basic configuration, computing device 1800 typically includes one or more processing units 1802 including one or more CPUs and one or more GPUs. Computing device 1800 also includes system memory 1804. Depending on the exact configuration and type of computing device, system memory 1804 may include volatile memory 1805 (such as RAM), non-volatile memory 1807 (such as ROM, flash memory, etc.) or some combination of the two. This most basic configuration is illustrated in FIG. 18 by dashed line 1806. Additionally, device 1800 may also have additional features/functionality. For example, device 1800 may also include additional storage (removable and/or non-removable) including, but not limited to, magnetic or optical disks or tape. Such additional storage is illustrated in FIG. 14 by removable storage 1808 and non-removable storage 1810.

Device 1800 may also contain communications connection(s) 1812 such as one or more network interfaces and transceivers that allow the device to communicate with other devices. Device 1800 may also have input device(s) 1814 such as keyboard, mouse, pen, voice input device, touch input device, etc. Output device(s) 1816 such as a display, speakers, printer, etc. may also be included. These devices are well known in the art so they are not discussed at length here.

Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. An input device to receive input from a user, the input device comprising:
a touch surface that receives a touch input;
a member, coupled to the touch surface, wherein the member is curved around a wrist in a first mode of operation, and wherein the member is flat in a second mode of operation;
a biometric sensor that receives a biometric input; and
a transmitter that outputs a signal that represents the touch and biometric inputs.

2. The input device of claim 1, wherein the touch input includes at least one of a touch of the touch surface or a gesture of a character when in the first mode of operation, and wherein the touch input from the user includes multiple touches of the touch surface in the second mode of operation.

3. The input device of claim 2, wherein the multiple touches of the touch surface forms a text message.

4. The input device of claim 1, further comprising a sticker having a first surface affixed to the touch surface by an adhesive and a second surface defining a key layout.

5. The input device of claim 1, wherein the touch surface includes a capacitive touch surface having a conducting layer to form a uniform electrostatic field when a voltage is provided to the conducting layer.

6. The input device of claim 1, further comprising an inertial sensing unit that detects an orientation of the input device.

7. The input device of claim 6, wherein the orientation of the input device includes at least one of portrait, landscape, one handed operation or two handed operation.

8. The input device of claim 1, wherein the biometric sensor includes at least one of heart rate sensor, blood/oxygen sensor, accelerometer or thermometer.

9. The input device of claim 1, wherein the transmitter outputs a wireless signal having a signal type including at least one of WiFi, Bluetooth, infrared, infrared personal area network, radio frequency Identification (RFID), wireless Universal Serial Bus (WUSB), cellular, 3G or 4G.

10. The input device of claim 1, further comprising:
a memory to store executable processor readable instructions; and
a processor to execute the processor readable instructions in response to the touch and biometric input.

11. A method of operating a member having a capacitive surface, the method comprising:
receiving a touch on the capacitive surface while the member is curved, wherein the touch represents input information;
receiving biometric information;
transmitting input and biometric information;
receiving multiple touches on the capacitive surface while the member is flat, wherein the multiple touches represent another input information; and
transmitting another input information.

12. The method of claim 11, further comprising:
receiving a first sticker on at least a portion of the capacitive surface that defines one or more locations corresponding to predetermined input while the member is curved; and
receiving a second sticker on at least a portion of the capacitive surface that defines one or more different locations corresponding to predetermined input while the member is flat.

13. The method of claim 11, wherein transmitting the input information, biometric information and another input information includes transmitting one or more wireless signals.

14. The method of claim 11, wherein another information is information representing a text message and wherein biometric information includes at least one of a heart rate or blood information.

15. An apparatus comprising:
an input device including:
a member, wherein the member may be curved to be worn or flat;
a touch surface, coupled to the member, that receives touch input;
a biometric sensor that receives biometric input;
a memory to store executable processor readable instructions; and
a processor to execute the processor readable instructions in response to the touch and biometric input; and
a wireless transmitter that outputs a wireless signal that represents the touch and biometric input; and
a computing device that receives the wireless signal and provides an electronic signal representing augmented reality information in response to the wireless signal.

16. The apparatus of claim 15, wherein the input device further comprises a power supply to provide a voltage, wherein the capacitive touch surface includes a conducting layer that forms a uniform electrostatic field in response to the voltage from the power supply, wherein the capacitive touch surface further includes at least one sensor that measures a signal that indicates a change in capacitance from a touch of the capacitive touch surface.

17. The apparatus of claim 16, wherein the executable processor readable instructions includes a software driver, and wherein the processor executes the software driver to determine a location of the touch in response to the signal that indicates the change in capacitance.

18. The apparatus of claim 15, wherein the input device further comprises a sticker having a first surface affixed to the touch surface by adhesive and a second surface defining one or more locations on the touch surface that corresponds input.

19. The apparatus of claim 15, wherein the input device further comprising an inertial sensing unit to detect an orientation of the input device.

20. The apparatus of claim 19, wherein the input device receives multiple touches of the touch surface to form a text message when the input device is flat.
